(19) United States
(12) Patent Application Publication
(10) Pub. No.: US 2009/0017379 A1
(43) Pub. Date: Jan. 15, 2009

(54) SECONDARY BATTERY, POWER SUPPLY SYSTEM USING SAME AND USAGE OF POWER SUPPLY SYSTEM

(75) Inventors: Yuu Inatomi, Osaka (JP); Nobuhiko Hojo, Osaka (JP); Masaaki Kuranuki, Kyoto (JP)

Correspondence Address: MCDERMOTT WILL & EMERY LLP, 600 13TH STREET, NW, WASHINGTON, DC, 20005-3096, US

(73) Assignee: MATSUSHITA ELECTRIC INDUSTRIAL CO., LTD., Osaka (JP)

(21) Appl. No.: 11/915,456

(22) PCT Filed: May 30, 2006
(86) PCT No.: PCT/JP2006/310728

§ 371 Date: Nov. 26, 2007

(30) Foreign Application Priority Data
May 31, 2005 (JP) 2005-158701

(51) Int. Cl. H01M 4/60; H01M 10/44

(52) U.S. Cl. 429/213; 320/101

(57) ABSTRACT

A secondary battery is equipped with a reaction container and a current collector that is built in at least one of a positive electrode side and a negative electrode side. The positive electrode side and the negative electrode side are separated from each other by an ion conductive separator. In the reaction container, an organic matter excluding a metal complex and a radical and capable of reversibly being electrochemically oxidized and reduced is used as an active material together with a supporting salt. The active material and the supporting salt form a liquid. On the surface of the current collector, the active material contained in the liquid is charged and discharged.

### RELATED APPLICATIONS

This application is the U.S. National Phase under 35 U.S.C. § 371 of International Application No. PCT/JP2006/310728, filed on May 30, 2006, which in turn claims the benefit of Japanese Application No. 2005-158701, filed on May 31, 2005, the disclosures of which Applications are incorporated by reference herein.

### TECHNICAL FIELD

The present invention relates to a secondary battery having a liquid-state electrode including an organic compound as an active material and a power supply system using the same.

### BACKGROUND ART

A secondary battery is a system for accumulating and releasing electric energy by charging and discharging. At present, secondary batteries have been widely used for, for example, a power supply of small-size portable devices, a mobile power supply for electric vehicles, a very large power supply for electric power or energy storage or for leveling the power output. In general, for secondary batteries, electrochemically oxidizable and reducible reactive species are used as an active material. Such an active material and a current collector form an electrode body. The electrode body and an electrolyte form a secondary battery. In lead storage batteries, nickel-cadmium storage batteries, nickel hydrogen storage batteries, or lithium ion secondary batteries, which have been widely used conventionally, a solid active material is fixed to a current collector to form an electrode body. In these batteries, the electrode body apparently keeps a solid state when it is oxidized and reduced.

On the other hand, a redox flow battery and the like using a kind of liquid state electrode body has been known, in which an active material dissolved in a supporting salt is brought into contact with a current collector.

Conventionally, as the redox flow battery, a reaction system has been widely investigated, in which an aqueous sulfuric acid solution or an aqueous hydrochloric acid solution is used as an electrolytic solution, V⁵⁺/V⁴⁺, Cr³⁺/Cr²⁺ or Fe³⁺/Fe²⁺ is used for the positive electrode, and V³⁺/V²⁺ or Fe²⁺/Fe¹⁺ is used for the negative electrode. However, inorganic redox flow batteries using heavy metal ions have limitations in attaining high-capacity and high-power, due to the limitation of solubility of active materials in the electrolytic solution, the limitation of reaction potential due to the use of the aqueous electrolytic solutions, and the like. Furthermore, since heavy metals have a problem about environmental load, it is desirable that the use of them should be avoided as much as possible.

On the other hand, in aiming to increase capacity, researches for using an organic compound with less environmental load as an active material have been also progressed. Japanese patent Unexamined Publication No. sho 58-133788 discloses an electrolytic solution in which a metallic complex salt is dissolved in a nonaqueous solution so that the concentration becomes 0.5% or more or the electrical conductivity becomes 1×10⁻¹Ω·cm⁻¹ or more. Furthermore, it also discloses that the electrochemical reaction of the organic compound can be used for the redox flow battery. Furthermore, it also discloses an electrolytic solution in which a metal such as Fe, Ru, Os, Ti, V, Cr, Mn, Co, Ni, and Cu forms a metal complex with bipyridine or phenanthroline. It also describes a power supply in which a redox flow battery using the organic compound and nonaqueous solution is integrated with a solar battery. Here, the nonaqueous solution contains propylene carbonate or acetonitrile.

However, in this configuration, the organic compound itself does not oxidize and reduce. This configuration intends to increase the dissolution concentration of ion species by allowing a transition metal to form a complex, and to improve the reaction speed, thus obtaining high power. In other words, the active material essentially includes a metal, and therefore the problem of environmental load cannot be dissolved.

On the other hand, Japanese patent Unexamined Publication No. 2003-36849 discloses a secondary battery having an active material contained in a liquid electrode, in which the active material is an electrically specific neutral radical compound. Furthermore, it discloses that this technique can be applied for an active material flow type battery using a liquid state electrode and that the current collector is a porous carbon body.

In this configuration, the radical compound is used for the active material. In general, a radical has a lifetime. Furthermore, a radical is characterized by growing up to a macromolecule by polymerization. Therefore, the active material including the radical compound loses the function as an active material or grows up to a macromolecule and increases the impedance of the current collector during the charge and discharge process, whereby may deteriorate the property. In this configuration, the above-mentioned problems are dissolved by using a stable radical compound, however, the energy density per volume is small, so that the capacity per volume of a battery becomes small.

### SUMMARY OF THE INVENTION

The present invention provides a new type of secondary battery using an organic compound excellent in reversibility as an active material. No heavy metal is used so as to avoid the problem of environmental load. No radical is also used so as to avoid the deterioration of battery performance. Furthermore, the present invention relates to a power supply system using the secondary battery. The secondary battery is essentially composed of a positive electrode active material, a positive electrode current collector, a negative electrode active material, a negative electrode current collector and a separator. The positive electrode current collector oxidizes and reduces the positive electrode active material, and the negative electrode current collector oxidizes and reduces the negative electrode active material. The ion conductive separator separates at least between the positive electrode active material and the negative electrode active material. At least one of the positive electrode active material and the negative electrode active material is an organic compound excluding a metal complex and a radical compound. The organic compound serving as an active material is in a liquid state or is used in a state being dissolved in a liquid. The organic compound is reversibly electrochemically oxidized and reduced in a state being dissolved in a supporting salt. In this configuration, a heavy metal is not used so as to prevent the problem of environmental load, and a radical is not applied so as to avoid deterioration of the property. In this way, can be obtained a new type of secondary battery having an excellent lifetime property. Furthermore, in a power supply system combining such a secondary battery and a power supply for supplying electric power to this secondary battery, electric power can be efficiently used. In particular, when a fuel cell, a solar battery or a commercial power supply is combined as the power supply, the disadvantages of the secondary battery and the power supply can be compensated with each other, thereby electric power can be efficiently supplied when a load is rapidly changed.

### BRIEF DESCRIPTION OF THE DRAWINGS

FIG. 1 is an outline drawing showing a configuration of a redox flow battery in accordance with a first exemplary embodiment of the present invention.

FIG. 2 is a schematic view to illustrate a reaction mechanism when a secondary battery is discharged in accordance with the first exemplary embodiment of the present invention.

FIG. 3 is an outline drawing showing a configuration of another redox flow battery in accordance with the first exemplary embodiment of the present invention.

FIG. 4 is a conceptual diagram showing a power supply system in accordance with a second exemplary embodiment of the present invention.

FIG. 5 is a conceptual diagram showing another power supply system in accordance with the second exemplary embodiment of the present invention.

FIG. 6 is a conceptual diagram showing a still another power supply system in accordance with the second exemplary embodiment of the present invention.

FIG. 7 is a conceptual diagram showing a power supply system in accordance with a third exemplary embodiment of the present invention.

FIG. 8 is a conceptual diagram showing another power supply system in accordance with the third exemplary embodiment of the present invention.

FIG. 9 is a conceptual diagram showing a power supply system in accordance with a fourth exemplary embodiment of the present invention.

FIG. 10 is a conceptual diagram showing another power supply system in accordance with the fourth exemplary embodiment of the present invention.

### DETAILED DESCRIPTION OF THE PREFERRED EMBODIMENTS

Hereinafter, exemplary embodiments of the present invention are described with reference to drawings. The present invention is not limited to the below-mentioned contents as long as it is based on the basic feature described in the specification.

### First Exemplary Embodiment

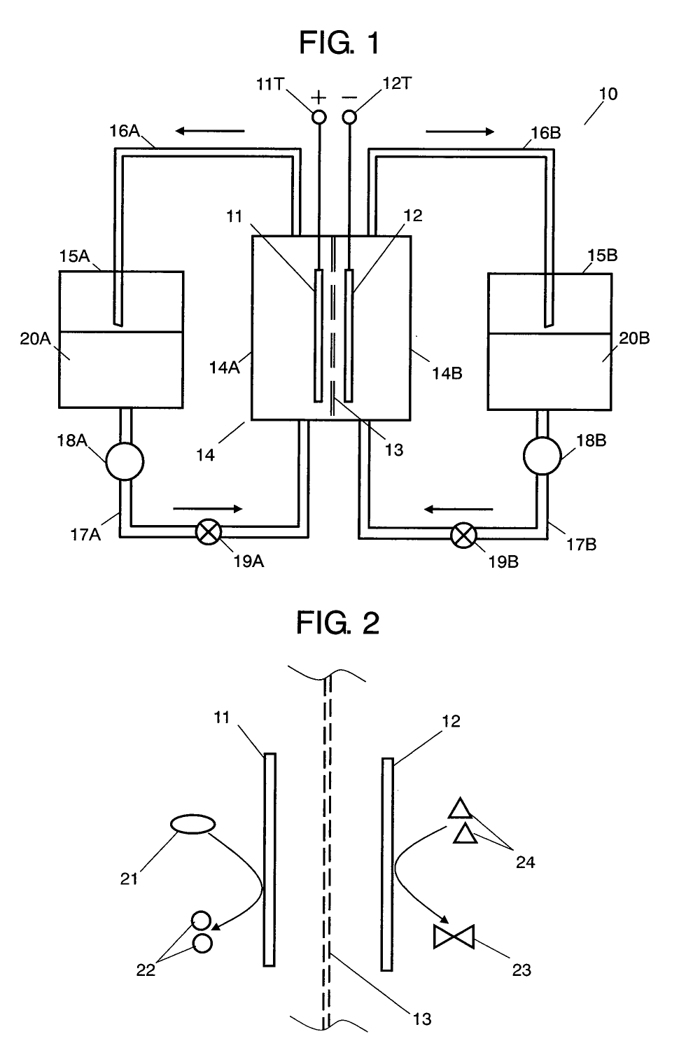

FIG. 1 is an outline view showing a configuration to illustrate the basic structure of a redox flow battery that is one kind of a secondary battery in accordance with the exemplary embodiment of the present invention. Positive electrode current collector 11 (hereinafter, referred to as current collector 11) contained in container 14 and oxidizing and reducing a positive electrode active material is coupled to positive electrode terminal 11T outside of container 14. Similarly, negative electrode current collector 12 (hereinafter, referred to as current collector 12) oxidizing and reducing a negative electrode active material is coupled to negative electrode terminal 12T. Container 14 is separated into positive electrode chamber 14A and negative electrode chamber 14B by separator 13. Current collector 11 is contained in positive electrode chamber 14A, and current collector 12 is contained in negative electrode chamber 14B.

Tank 15A contains positive electrode solution 20A including an organic compound as the positive electrode active material, and tank 15B contains negative electrode solution 20B including an organic compound as the negative electrode active material. Pump 18A transports positive electrode solution 20A between tank 15A and positive electrode chamber 14A via piping 16A, piping 17A and valve 19A. Pump 18B transports negative electrode solution 20B between tank 15B and negative electrode chamber 14B via piping 16B, piping 17B and valve 19B. Tank 15A, piping 16A, piping 17A, pump 18A and valve 19A form a supplying portion for supplying a positive electrode active material from the outside of container 14. Tank 15B, piping 16B, piping 17B, pump 18B and valve 19B form a supplying portion for supplying a negative electrode active material from the outside of container 14. Thus, redox flow battery 10 (hereinafter, referred to as battery 10) with free capacity design is configured.

In the structure shown in FIG. 1, a supplying portion of an active material is provided in both the positive electrode side and the negative electrode side. However, any one of these supplying portions may be deleted or at least one of the supplying portions may be formed in a cartridge.

For current collectors 11 and 12, materials that are stable against the applied solvent or supporting salt and also stable against an electrochemical reaction that is an electrode reaction may be used. They can be selected from the materials such as metal, carbon, an electroconductive polymer. As the structures of current collectors 11 and 12, a smooth plate can be applied. Furthermore, in order to increase the contact probability with respect to a liquid active material, it is preferable to use a structure whose surface area is increased, for example, a perforation plate, a wave plate, a mesh, a surface-roughened plate, a sintered porous body, and the like.

For separator 13 separating between positive electrode solution 20A and negative electrode solution 20B, not only a simple fine porous membrane (porous body) that is used for general secondary batteries but also a porous membrane such as glass paper obtained by weaving a glass fiber into non-woven fabric can be used. Furthermore, an ion conductive barrier membrane can be used. As such materials, an ion exchange resin such as a cation exchange membrane and an anion exchange membrane, or a solid electrolyte is preferable.

Positive electrode solution 20A and negative electrode solution 20B include an organic compound as an active material, respectively. Such an organic compound itself may be a liquid or may be a compound dissolved in a solvent. In an electrochemical oxidation and reduction reaction using an organic compound as an active material, it is necessary that the organic compound coexists with a supporting salt working as an electrolyte. That is to say, when the organic compound working as an active material is liquid, a supporting salt can be dissolved in the active material, and the resulting solution can be contained in container 14. Furthermore, regardless of whether the organic compound is liquid or solid, it can be dissolved in a solvent together with a supporting salt, and the resulting solution can be contained in container 14.

As the latter case, when a supporting salt and a solvent are used, a solvent capable of dissolving both an organic active material and a supporting salt can be widely applied. For the secondary battery of the present invention, a non-aqueous solvent used in an electrolytic solution of an existing lithium battery can be applied. Furthermore, in the case where the dissolution/precipitation or absorption/release of an alkaline metal such as lithium or a metal such as magnesium is not used for an electromotive reaction of the negative electrode, water or a mixture of water and an organic solvent can be used. In other words, water may be used as the solvent.

As the supporting salt, it is preferable to use an acid salt or a basic salt such as H₂SO₄, HCl, LiOH, KOH, and the like, and furthermore, to use a lithium salt such as LiPF₆, LiClO₄, LiBF₄, LiCF₃SO₃, LiN(CF₃SO₂)₂, and LiC(C₂F₅SO₂)₃ that dissociates a relatively large anion, a sodium salt, a magnesium salt, and the like. Furthermore, an ambient temperature molten salt can be used. An ambient temperature molten salt that contains an organic quaternary ammonium cation is preferred.

An example of the organic quaternary ammonium cation may include imidazolium cation, tetraalkylammonium cation, pyridinium cation, pyrrolium cation, pyrazolium cation, pyrrolidinium cation, piperidinium cation, and the like.

An example of the imidazolium cation may include a dialkylimidazolium cation such as 1,3-dimethylimidazolium ion, 1-ethyl-3-methylimidazolium ion, 1-methyl-3-ethylimidazolium ion, 1-butyl-3-methylimidazolium ion, and the like.

Furthermore, an example of the trialkylimidazolium cation may include 1,2,3-trimethylimidazolium ion, 1,2-dimethyl-3-ethylimidazolium ion, 1,2-dimethyl-3-propylimidazolium ion, and the like.

An example of the tetraalkyl ammonium cation may include trimethyl ethyl ammonium ion, trimethyl propyl ammonium ion, trimethyl hexyl ammonium ion, tetrapentyl ammonium ion, and the like. However, the tetraalkyl ammonium cation is not limited to them.

An example of the pyridinium ion may include N-methylpyridinium ion, N-ethyl pyridinium ion, N-propyl pyridinium ion, N-butyl pyridinium ion, 1-ethyl-2-methylpyridinium ion, 1-butyl-4-methylpyridinium ion, 1-butyl-2,4-dimethyl pyridinium ion, and the like.

An example of the pyrrolium cation may include 1,1-dimethylpyrrolium ion, 1-ethyl-1-methylpyrrolium ion, 1-methyl-1-propylpyrrolium ion, and the like.

An example of the pyrazolium cation may include 1,2-dimethyl-3,5-diphenyl pyrazolium ion, and the like.

An example of the pyrrolidinium cation may include 1,1-dimethyl pyrrolidinium ion, 1-ethyl-1-methylpyrrolidinium ion, 1-methyl-1-propyl pyrrolidinium ion, 1-butyl-1-methylpyrrolidinium ion, and the like.

An example of the piperidinium cation may include 1,1-dimethylpiperidinium ion, 1-ethyl-1-methylpiperidinium ion, 1-methyl-1-propylpiperidinium ion, 1-butyl-1-methylpiperidinium ion, and the like.

The ambient temperature molten salt including such organic quaternary ammonium cations may be used singly or in a combination of two or more kinds thereof.

Furthermore, the anion of the nonaqueous electrolyte is preferably selected from an anion that is composed of only non-metallic elements. As such an anion, there may be preferably selected at least one kind anion from the group consisting of OH⁻, BF₄⁻, PF₆⁻, CF₃SO₃⁻, N(CF₃SO₂)₂⁻, N(C₂F₅SO₂)₂⁻, N(CF₃SO₂)(C₄F₉SO₂)⁻, C(CF₃SO₂)₃⁻ and C(C₂F₅SO₂)₃⁻. However, it is not limited to these anions. These may be used singly or in a combination of two or more kinds thereof. Furthermore, the anion of the ambient temperature molten salt and the anion of the lithium salt may be the same as each other or may different from each other.

As the solvent, it is preferable to use a single organic solvent such as ethylene carbonate, propylene carbonate, dimethyl carbonate, diethyl carbonate, methyl ethyl carbonate, γ-butyrolactone, propylene carbonate, tetrahydrofuran, dioxolane, sulfolane, dimethylformamide, diethylformamide, and the like, or a mixed solvent of two or more thereof. Furthermore, as the liquid organic compound, it is preferable to use a liquid organic compound having a π electron conjugated cloud. An example of such an organic compound may include the below mentioned compounds shown by general formula (1), general formula (2), general formula (3), general formula (4), or general formula (5). Such compounds are preferable because they have a large capacity density, a high reversibility of charging and discharging, and a large reaction speed.

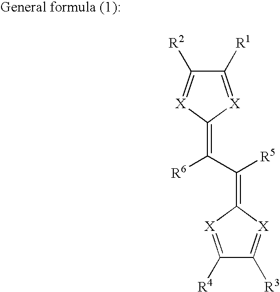

(wherein X represents a nitrogen atom; R¹ to R⁴ each independently represents a chain saturated or unsaturated aliphatic group, a cyclic saturated or unsaturated aliphatic group, a hydrogen atom, a hydroxyl group, a cyano group, an amino group, a nitro group or a nitroso group; R⁵ and R⁶ each independently represents a chain saturated or unsaturated aliphatic group or a cyclic saturated or unsaturated aliphatic group; and the aliphatic group includes at least one selected from the group consisting of an oxygen atom, a nitrogen atom, a sulfur atom, a silicon atom, a phosphorus atom, a boron atom and a halogen atom).

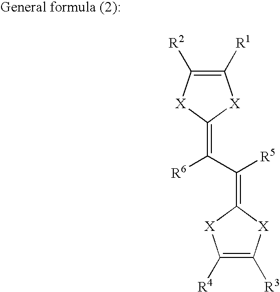

(wherein X represents a sulfur atom or an oxygen atom; R¹ to R⁴ each independently represents a chain saturated or unsaturated aliphatic group, a cyclic saturated or unsaturated aliphatic group, a hydrogen atom, a hydroxyl group, a cyano group, an amino group, a nitro group or a nitroso group; R⁵ and R⁶ each independently represents a chain saturated or unsaturated aliphatic group or a cyclic saturated or unsaturated aliphatic group; and the aliphatic group includes at least one selected from the group consisting of an oxygen atom, a nitrogen atom, a sulfur atom, a silicon atom, a phosphorus atom, a boron atom and a halogen atom).

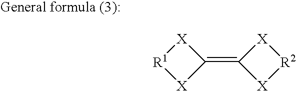

(wherein R¹ and R² each independently represents a chain saturated or unsaturated aliphatic group or a cyclic saturated or unsaturated aliphatic group; R¹ and R² may be the same as each other or different from each other; X represents a sulfur atom, an oxygen atom, or a tellurium atom; and the aliphatic group includes at least one selected from the group consisting of a hydrogen atom, an oxygen atom, a nitrogen atom, a sulfur atom, a silicon atom, a phosphorus atom, a boron atom and a halogen atom).

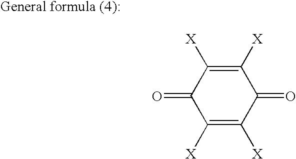

(wherein X represents a halogen atom, a hydrogen atom, a cyano group, a chain saturated or unsaturated aliphatic group, or a cyclic saturated or unsaturated aliphatic group; and Xs may be the same as each other or different from each other).

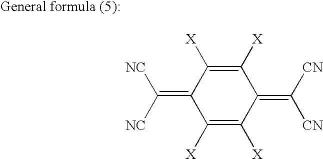

(wherein X represents a halogen atom, a hydrogen atom, a cyano group, a chain saturated or unsaturated aliphatic group, or a cyclic saturated or unsaturated aliphatic group; and Xs may be the same as each other or different from each other).

When such materials are used, it is possible to obtain a secondary battery having a large energy density and capable of charging and discharging at a large current.

In addition to the above, when an organic compound having a thiol group is used for the organic compound, a secondary battery having a large energy density can be obtained. An example of the organic compound may include disulfide materials with a small molecular weight, for example, Ph-S—S-Ph (Ph represents a phenyl group), CH₃—S—S—CH₃, a disulfide material having a benzene ring with a fluorine molecule, and the like. Such materials can be used in a state in which a supporting salt such as ambient temperature molten salt, for example, LiBF₄, ethyl methyl imidazolium, and the like, is dissolved.

In FIG. 1, a liquid electrode body including an organic compound as an active material is used in both the positive electrode side and negative electrode side. Other than this, it is possible to use an electrode system having a liquid electrode for at least one of the positive electrode and the negative electrode and as the counter electrode thereof a solid active material or an ion absorbing/releasing type active material that is similar to the conventional secondary battery. For example, a lithium metal, a graphite material electrode, a silicon material electrode, and a tin material electrode can be used together with a supporting body. These electrodes can be applied regardless of whether a lithium ion is contained or not.

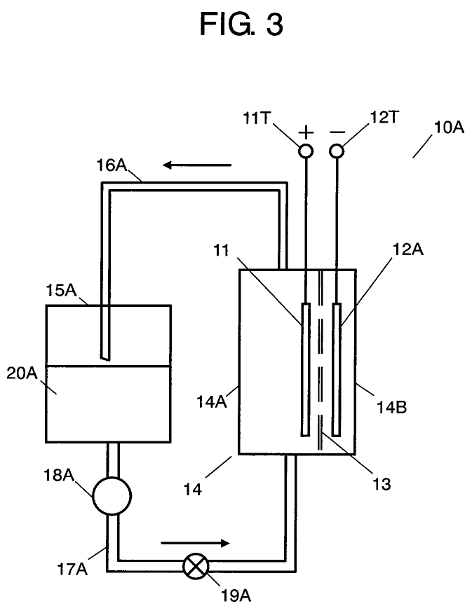

FIG. 3 is an outline diagram of a configuration showing an example of such a battery. In FIG. 3, the same reference numerals are given to the same elements as those in FIG. 1 and the description therefore is omitted. The positive electrode side of battery 10A has the same structure as that of battery 10 shown in FIG. 1. On the negative electrode side, in negative electrode chamber 14B, graphite porous electrode 12A that is a negative electrode for a conventional lithium secondary battery is used. In this case, separator 13 is formed of a solid electrolyte and brought into close contact with porous electrode 12A or an electrolytic solution in which a supporting salt is dissolved may be filled in negative electrode chamber 14B.

In FIGS. 1 and 3, positive electrode chamber 14A and negative electrode chamber 14B are shown as a single body. These reaction chambers may be combined in series or in parallel, thus enabling the voltage or capacity to be increased. In this case, in order to avoid short-circuit. Homopolar liquid active materials combined in series are separated in each reaction chamber. For example, at appropriate portions, not-continuous portions are provided in dropping spot.

Next, the organic compound working as an active material and the reaction thereof are described. FIG. 2 is a schematic view to illustrate a reaction mechanism of the secondary battery at the time of discharging in accordance with the first exemplary embodiment. Positive electrode active material oxidized product 21 is brought into contact with current collector 11 in positive electrode solution 20A in the presence of a supporting salt ion, and is electrochemically reduced to positive electrode active material reduced product 22. On the other hand, negative electrode active material reduced product 24 is brought into contact with current collector 12 in negative electrode solution 20B in the presence of a supporting salt ion, and is electrochemically oxidized to negative electrode active material oxidized product 23. Positive electrode active material reduced product 22 and negative electrode active material oxidized product 23, which are reaction products, are immediately departed from current collector 11 and current collector 12, respectively, and dissolved in positive electrode solution 20A and negative electrode solution 20B including a supporting salt, again. Furthermore, at the time of charging, the reaction opposite to this reaction occurs. With such a reversible reaction, the charge and discharge of battery 10 proceeds. The reaction mechanism in the oxidation-reduction reaction is common in that electromotive force is based on the electrochemical and reversible oxidation-reduction reaction potential between the oxidized and the reduced products although depending upon the kinds of the organic compounds.

The organic compound as an active material in this exemplary embodiment is dissolved in a solvent at much higher concentration as compared with a conventional heavy metal-based aqueous solution in the temperature range from 0° C. or less to about 100° C., and heating and the like is not necessary. Therefore, the range of the operation temperature of the battery is broad. However, in the case of an aqueous solution, when the temperature is 0° C. or less, water is solidified, so that the active material cannot be dissolved in the solution and moreover cannot be used for operating a battery.

Furthermore, a redox flow battery using a vanadium-based material is generally used at an active material concentration of about 1.5 to 2 mol/L. However, for example, the compounds represented by general formula (1) include one dissolved at the concentration of about 10 mol/L. Furthermore, since the vanadium-based active material solution contains a heavy metal, the specific gravity is so large as about 6 g/cm³. On the contrary, when the organic compound is used as an active material, the specific gravity is about 1.0 g/cm³, so that the entire battery can be designed to have a light weight.

For such an organic compound as an active material, an organic compound having a π electron conjugated cloud and an organic compound having a thiol group in the molecule are preferably used. An organic compound represented by any of general formulae (1) to (3) and having a π electron conjugated cloud, an organic compound having a quinone based site and having a structure represented by any of general formulae (4) and (5), and an organic compound having a thiol group can be used as an active material as long as they are dissolved in the solvent. The molecular weight is not particularly limited. Among them, an organic compound having a π electron conjugated cloud shows a high reaction speed and an excellent reversibility. Hereinafter, these compounds are described. Firstly, an organic compound having a π electron conjugated cloud is described in detail.

A compound having a π electron conjugated cloud (hereinafter, referred to as a π electron conjugated compound) has a relatively flat molecular structure. When this molecule is electrochemically oxidized or reduced by charge and discharge, the electron state on the π electron cloud is changed without changing the basic molecular structure. Therefore, this molecule forms a stable oxidized or reduced product by rapidly coordinating anions or cations coexisting in the vicinity thereof and is dissolved in a solution. Furthermore, on the contrary, when the oxidized or reduced product formed by charge is discharged, this molecule releases the coordinated anions or cations rapidly, and the molecule itself returns to the original molecular state and dissolved in the solution.

This mechanism does not involve diffusion resistance accompanied with the interlayer transport of cations as is found in such as a layered compound of LiCoO₂, and the like. The compound represented by any one of the general formulae (1) to (3) is a preferable material which can expect rapid charge and discharge. In this way, the π electron conjugated compound attains a large reaction speed. Therefore, a battery using such a material as an active material can charge and discharge at a large current. Among the π electron conjugated compounds exerting such reversibility, an organic compound having a structure represented by any one of the above-mentioned general formulae (1) to (3) is excellent in the reaction speed and reversibility.

The compounds represented by general formula (1), general formula (2), or general formula (3) include the compound disclosed by the present inventors in Japanese patent Unexamined Publication Nos. 2004-111374 and 2004-342605. An example of the compound represented by general formula (2) may include a compound represented by general formula (6) or a compound represented by formula (7).

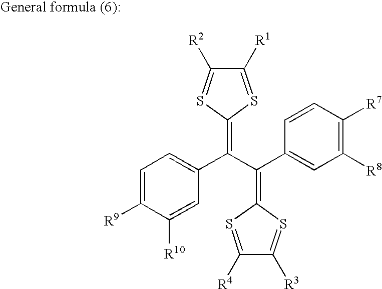

wherein R¹ to R⁴ and R⁷ to R¹⁰ each represents a chain saturated or unsaturated aliphatic group, a cyclic saturated or unsaturated aliphatic group, a hydrogen atom, a hydroxyl group, a cyano group, an amino group, a nitro group or a nitroso group; and the aliphatic group includes at least one selected from the group consisting of an oxygen atom, a nitrogen atom, a sulfur atom, a silicon atom, a phosphorus atom, a boron atom and a halogen atom.

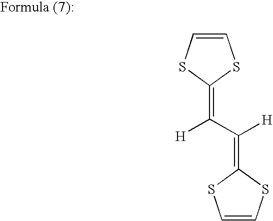

The compound represented by formula (7) has a small molecular weight and is expected to have a high capacity among the compounds represented by general formula (2).

Furthermore, in the group of compounds represented by general formula (6), by the presence of the benzene rings positioned nearby the two five-membered rings, it is thought that the energy levels at which electrons are pulled out from the two five-membered rings become close to each other and the reaction proceeds as if it were a one-electron reaction. Therefore, the reaction speed becomes faster as compared with the case where R⁵ and R⁶ do not contain a benzene ring in general formula (2). Typical examples of the compound represented by general formula (6) include the compounds represented by formulae (8) to (11).

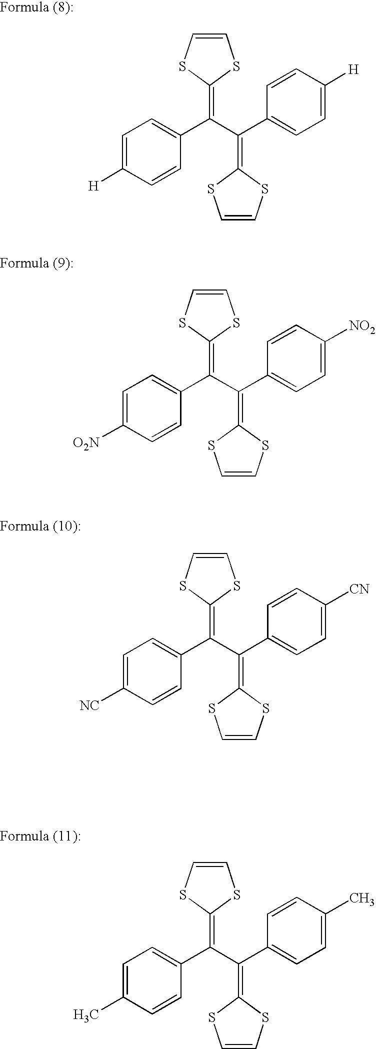

Furthermore, when the compound represented by formula (12) belonging to general formula (1) is used, since the potential is low, it can be used as a negative electrode active material. When the compound represented by formula (12) is used as a negative electrode active material, for the positive electrode active material, for example, it is possible to use an oxide electrode such as LiCoO₂ capable of absorbing and releasing a lithium ion, which is generally used for a lithium secondary battery.

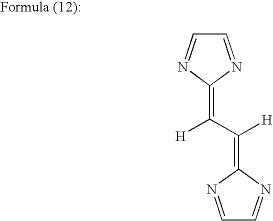

Next, the compound represented by general formula (3) is described. In general formula (3), the aliphatic group represented by R¹ and R² is not particularly limited. However, an aliphatic group having 1 to 6 carbon atoms is preferred. In particular, it is preferable to select the aliphatic group so that the structure of general formula (3) has a structure in which two annular T electron groups are linked to each other via a double bond.

An example of the compound having the structure represented by general formula (3) includes a compound represented by general formula (13).

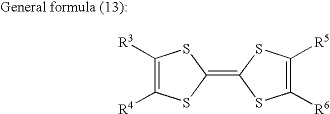

wherein R³ to R⁶ each independently represents a chain saturated or unsaturated aliphatic group, a cyclic saturated or unsaturated aliphatic group, a hydrogen atom, a hydroxyl group, a cyano group, an amino group, a nitro group or a nitroso group, R³ to R⁶ may be the same as each other or different from each other; and the aliphatic group can include at least one selected from the group consisting of an oxygen atom, a nitrogen atom, a sulfur atom, a silicon atom, a phosphorus atom, a boron atom and a halogen atom.

In the compound having a structure represented by general formula (13), the aliphatic group includes, for example, an alkyl group, a cycloalkyl group, an alkoxy group, a hydroxyalkyl group, a thioalkyl group, an aldehyde group, a carboxylic acid group, an alkyl halide group, and the like. The compounds represented by formulae (14), (15), and (16), and the compounds represented by general formulae (17), (18), and (19) are included.

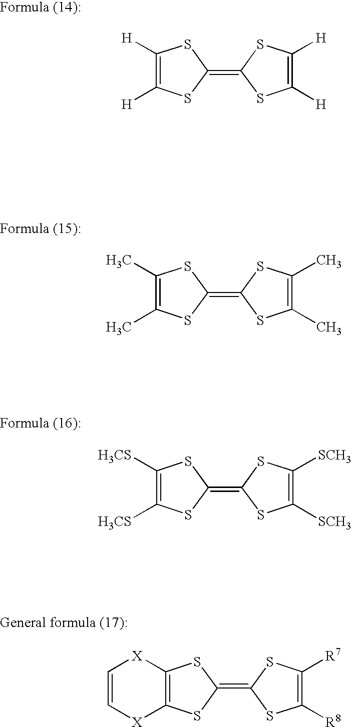

wherein R⁷ and R⁸ each independently represents a chain saturated or unsaturated aliphatic group, a cyclic saturated or unsaturated aliphatic group, a hydrogen atom, a hydroxyl group, a cyano group, an amino group, a nitro group or a nitroso group, R⁷ and R⁸ may be the same as each other or different from each other; X represents a sulfur atom, an oxygen atom, a carbon atom or a tellurium atom; and the aliphatic group includes at least one selected from the group consisting of an oxygen atom, a nitrogen atom, a sulfur atom, a silicon atom, a phosphorus atom, a boron atom and a halogen atom.

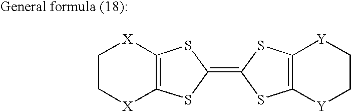

wherein X and Y each independently represents a sulfur atom, an oxygen atom, a carbon atom or a methylene group, and X and Y may be the same as each other or different from each other.

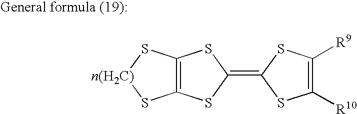

wherein R⁹ and R¹⁰ each independently represents a chain saturated or unsaturated aliphatic group, a cyclic saturated or unsaturated aliphatic group, a hydrogen atom, a hydroxyl group, a cyano group, an amino group, a nitro group or a nitroso group, R⁹ and R¹⁰ may be the same as each other or different from each other; the aliphatic group can include at least one selected from the group consisting of an oxygen atom, a nitrogen atom, a sulfur atom, a silicon atom, a phosphorus atom, a boron atom and a halogen atom; and n is 1 or more.

An example of the aliphatic group represented by R⁷ and R⁸ in general formula (17) and the aliphatic group represented by R⁹ and R¹⁰ in general formula (19) may include an alkyl group, a cycloalkyl group, an alkoxy group, a hydroxyalkyl group, a thioalkyl group, an aldehyde group, a carboxylic acid group, an alkyl halide group, and the like.

An example of the compound corresponding to general formula (17) may include compounds represented by formulae (20), (21) and (22).

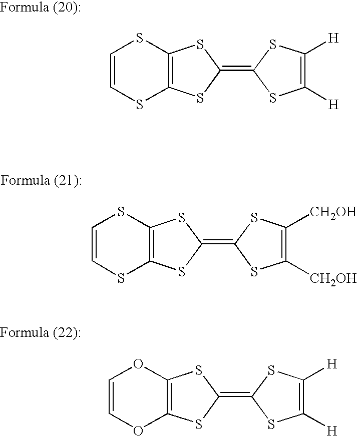

An example of the compound corresponding to general formula (18) may include compounds represented by formulae (23), (24) and (25).

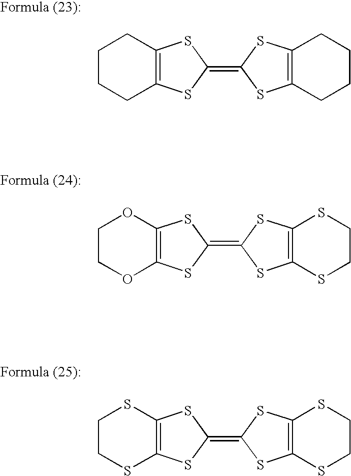

An example of the compound corresponding to general formula (19) may include a compound represented by formula (26).

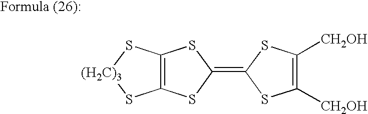

Furthermore, the compounds represented by formulae (27) and (28) also belong to general formula (13).

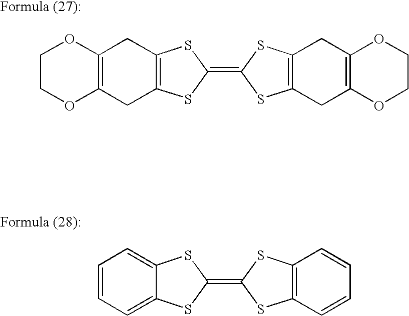

For the compound having a structure represented by general formula (3), a high molecular compound having plural structures represented by general formula (3) can be also used. It is preferable that such a compound has a polyacetylene chain, so that it expands the π electron cloud.

The compound represented by general formula (4) is quinones. It is preferable that substituent X is halogen or a cyano group having high electronegativity. The substituent X may be a hydrogen atom. The compound belonging to general formula (4) includes compounds represented by formulae (29), (30), (31), (32) and (33).

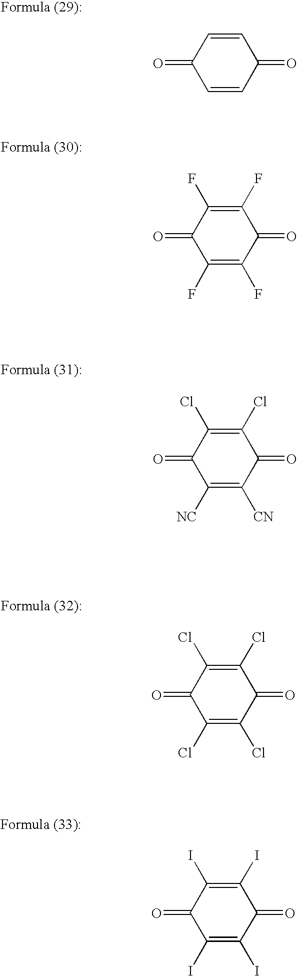

In general formula (4), an oxygen atom is bonded to the para position of the six-membered ring. However, a compound in which an oxygen atom is bonded to the ortho position may be included. Examples of such compounds may include a compound represented by general formula (34). Furthermore, a specific example thereof may include the compound represented by formula (35).

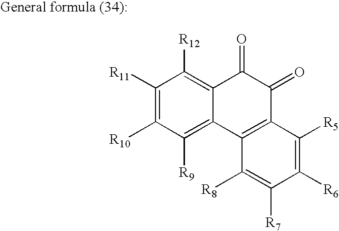

(wherein R⁵ to R¹² represent proton, fluorine, an alkyl group, or a saturated or unsaturated aliphatic group, and may include nitrogen, oxygen, silicon, and the like; the aliphatic group may have a straight chain or may form a ring; and R⁵ to R¹² may be the same as each other or different from each other).

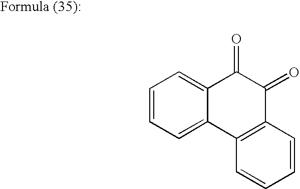

The compound represented by general formula (5) is a derivative of 7,7,8,8-tetracyano-quinodimethane (TCNQ), wherein substituent X is preferably halogen or a cyano group having high electronegativity but may be a hydrogen atom. Furthermore, when the compound is used as a negative electrode active material, the substituent X is desirably a methyl group, a methoxy group, a butyl group, and the like. Examples of the compound belonging to general formula (5) may include the compounds represented by formulae (36) and (37).

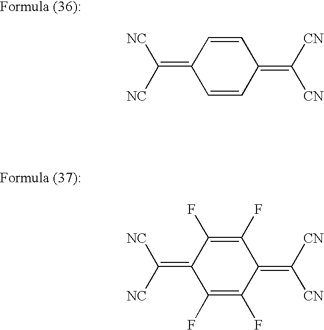

The organic compound having a thiol group in the molecule is described. One of such compounds, an organic disulfide compound is an organic compound generally having a —S—S— bonding such as R—S—S—R′ (R and R′ represent aliphatic or aromatic) in the molecule. The organic disulfide compound forms an oxidized product in which the S—S bond is cut by oxidization. That is to say, the oxidized product is a thiol compound having a group such as a —SH group or a SLi group at the terminal. The oxidized product is restored to the original organic disulfide compound molecule by reduction. In other words, the organic disulfide compound is a reduced product. An example of the organic thiol compound includes 2,5-dimercapto-1,3,4-thiadiazole that can be used as a negative electrode active material because it can be dissolved in a solvent.

In addition to these compounds, a reversibly oxidizable and reducible organic compound, which is in a liquid state and can dissolve a supporting salt or can be dissolved in a solvent with a supporting salt, can be used as the active material.

As mentioned above, the secondary battery in accordance with the first exemplary embodiment of the present invention can be a battery having a wide range of the operation temperature, a high-power property, and small environmental load, so that the setting place of the battery is not limited.

In battery 10 in accordance with the first exemplary embodiment, since container 14, tank 15A, and tank 15B are separated respectively and these are coupled by a transport and supply circuit (supplying portion) of an active material, they can be located in adequate positions with enough space. Furthermore, such a configuration can be applied to a small-size power supply for portable devices. In other words, tank 15A, tank 15B, the supplying portion and container 14 serving as a reaction portion can be assembled into a cassette so that they can be freely attached and detached and that they are allowed to become more suitable for portable applications. For example, a system can be configured in which container 14 is housed compactly in limited space inside electronic equipment and an active material is supplied from a place with enough room in the equipment or outside of the equipment. Furthermore, besides a redox flow battery, a closed type battery may be configured.

Hereinafter, the exemplary embodiment is described in detail with reference to specific examples. Note here that the present invention is not limited to the below mentioned examples.

(Sample A)

As current collectors 11 and 12, a graphite sintered body having a size of 30 mm in length, 10 mm in width, and 5 mm in thickness is used. Furthermore, as separator 13 for separating positive electrode chamber 14A and negative electrode chamber 14B from each other, 40 μm-thick glass paper is used. By using them, battery 10 having a liquid-state electrode using an organic compound excluding a metallic complex salt and a radical compound as an active material is produced in the configuration shown in FIG. 1. As a solvent, a solvent including an equal volume of methyl ethyl carbonate and diethyl carbonate is used. In the solvent, 1 mol/L of LiPF₆ as a supporting salt is dissolved so as to prepare a supporting salt solution.

As the positive electrode active material, an organic compound represented by formula (7) having a π electron conjugated cloud is used. This compound is dissolved in the above-mentioned supporting salt solution at the concentration of 10 mmol/L so as to prepare positive electrode solution 20A. Next, as the active material for a negative electrode, the compound represented by formula (12) is used, and this compound is dissolved in the above-mentioned supporting salt solution at the concentration of 10 mmol/L so as to prepare negative electrode solution 20B. Next, positive electrode solution 20A and negative electrode solution 20B are introduced in tank 15A and 15B, respectively. Thus, battery 10 based on the above-mentioned configuration is prepared.

(Sample B)

Sample B of battery 10 is produced similarly to sample A except that as the positive electrode active material, an organic compound represented by formula (28) having a π electron conjugated cloud is used; and as the negative electrode active material, an organic compound represented by formula (14) having a π electron conjugated cloud is used.

(Sample C)

Sample C of battery 10 is produced similarly to sample A except that as the positive electrode active material, 2-amino-4,6-mercaptopyridine that is an organic thiol compound is used and this is dissolved in the same supporting salt solution as in sample A so as to produce positive electrode solution 20A; and as the negative electrode active material, 2,5-dimercapto-1,3,4-thiadiazole that is a liquid state organic thiol compound is used and 1 mol/L of LiPF₆ serving as a supporting salt is dissolved in the thiol compound so as to produce negative electrode solution 20B.

(Sample D)

Sample D of battery 10 is produced similarly to sample A except that as the positive electrode active material, an organic compound represented by formula (32) having a π electron conjugated cloud is used, and as the negative electrode active material, an organic compound represented by formula (29) having a π electron conjugated cloud is used.

(Sample E)

Sample E of battery 10 is produced similarly to sample B except that a graphite porous electrode that is a negative electrode for a conventional lithium secondary battery is used instead of negative electrode current collector 12, and the supporting salt solution of sample A is used. That is to say, in this configuration, only for the positive electrode active material, an organic compound excluding a metallic complex salt and a radical compound is used.

(Sample F)

Sample F of battery 10 is produced similarly to sample B except that an electrode containing LiCoO₂ that is a positive electrode for a conventional lithium secondary battery and a carbon material as a conductive material is used instead of positive electrode current collector 11, and that a supporting salt solution of sample A is used. That is to say, in this configuration, only for the negative electrode active material, an organic compound excluding a metallic complex salt and a radical compound is used.

(Comparative Sample)

A comparative sample of battery is produced similarly to sample E except that as the positive electrode active material, 2, 2, 6, 6 tetramethyl piperidinoxyl radical derivative that is one of nitroxy radical organic compounds is used.

The summary of the above-mentioned configuration is shown in Table 1.

TABLE 1

| | | | Voltage |
|---|---|---|---|
| Battery | Positive electrode side | Negative electrode side | range |
| Sample | π electron conjugated | π electron conjugated | 2.0 V- |
| A | compound of | compound of | 3.5 V |
| | formula (7)/ | formula (12)/ | |
| | organic solvent + LiPF₆ | organic solvent + LiPF₆ | |
| Sample | π electron conjugated | π electron conjugated | 0.1 V- |
| B | compound of | compound of | 0.35 V |
| | formula (28)/ | formula (14)/ | |
| | organic solvent + LiPF₆ | organic solvent + LiPF₆ | |
| Sample | 2-amino-4,6- | 2,5-dimercapto-1,3,4- | 0.3 V- |
| C | mercaptopyridine/ | thiadiazole/LiPF₆ | 0.65 V |
| | organic solvent + LiPF₆ | | |
| Sample | π electron conjugated | π electron conjugated | 0.5 V- |
| D | compound of | compound of | 1.1 V |
| | formula (32)/ | formula (29)/ | |
| | organic solvent + LiPF₆ | organic solvent + LiPF₆ | |
| Sample | π electron conjugated | graphite electrode for | 2.0 V- |
| E | compound of | lithium secondary | 3.5 V |
| | formula (28)/ | battery/ | |
| | organic solvent + LiPF₆ | organic solvent + LiPF₆ | |
| Sample | LiCoO₂ electrode for | π electron conjugated | 3.0 V- |
| F | lithium secondary | compound of | 4.2 V |
| | battery/ | formula (14)/ | |
| | organic solvent + LiPF₆ | organic solvent + LiPF₆ | |
| Com- | 2,2,6,8 tetramethyl | graphite electrode for | 3.0 V- |
| para- | piperidinon radical | lithium secondary | 3.8 V |
| tive | derivative/ | battery/organic | |
| Sample | organic solvent + LiPF₆ | solvent + LiPF₆ | |

Next, in each battery, pump 18A and pump 18B if necessary are operated so as to operate a supply portion, and positive electrode solution 20A and negative electrode solution 20B are allowed to circulate at the flowing rate of 100 cm³/min. While the solutions are circulated, a charge and discharge test is carried out at a current density of 10 mA/cm² with respect to current collectors 11 and 12. At this time, the upper limit voltage and lower limit voltage of charge and discharge are selected as shown in Table 1.

As a result, samples A to F can be repeatedly charged and discharged 50 cycles or more. Furthermore, the capacity of the battery is hardly lowered even after the battery is charged and left for 30 days or more while pump 18A and pump 18B are stopped. Thus, the battery using glass paper for separator 13 does not cause any problem when the battery is subjected to the charging and discharging cycle or left in such a degree.

On the contrary, in the comparative sample, the capacity is lowered with the cycle. When the battery is left after charged, both capacity and flat voltage are remarkably lowered after several hours. The causes of the above deterioration are analyzed to be the lifetime of the radical but also the loss of the active material caused by radical polymerization and the increase of impedance on the surface of the current collector. Furthermore, since most of the radical compounds carry out a one-electron reaction, the capacity density is small. For example, the theoretical capacity density of the compound used for the comparative sample is 172 mAh/g. On the contrary, all of the compounds of the exemplary embodiments carry out a two-electron reaction. Therefore, the capacity density is large and the energy density as a battery is also large.

In addition to the active materials used in the samples, the compounds listed in the exemplary embodiment and the organic compounds that have a thiol group and are liquid state or that can be dissolved in the solvent also provide the same results as above.

Next, examples using an aqueous solution as a supporting salt solution are described.

(Sample K)

As current collectors 11 and 12, a sintered body of graphite having a size of 30 mm in length, 10 mm in width, and 5 mm in thickness is used. Furthermore, as separator 13 for separating positive electrode chamber 14A and negative electrode chamber 14B from each other, 40 m-thick glass paper is used. By using them, battery 10 having a liquid-state electrode using an organic compound excluding a metallic complex salt and a radical compound as an active material is produced in the configuration shown in FIG. 1. As a supporting salt solution, an aqueous solution in which 1 mol/L of LiCl is dissolved is used.

As the positive electrode active material, an organic compound represented by formula (36) having a π electron conjugated cloud is used. This compound is dissolved in the above-mentioned supporting salt solution at the concentration of 10 mmol/L so as to prepare positive electrode solution 20A. Next, as the active material for a negative electrode, the compound represented by formula (14) is used. This compound is dissolved in the above-mentioned supporting salt solution at the concentration of 10 mmol/L so as to prepare negative electrode solution 20B. Next, positive electrode solution 20A and negative electrode solution 20B are introduced in tank 15A and 15B, respectively. Thus, battery 10 based on the above-mentioned configuration is prepared.

(Sample L)

Sample L of battery 10 is produced similarly to sample K except that as the positive electrode active material, an organic compound represented by formula (37) having a π electron conjugated cloud is used and as the negative electrode active material, an organic compound represented by formula (36) having a π electron conjugated cloud is used.

(Sample M)

Sample M of battery 10 is produced similarly to sample K except that as the positive electrode active material, an organic compound represented by formula (30) a π electron conjugated cloud is used; as the negative electrode active material, an organic compound represented by formula (29) having a π electron conjugated cloud is used; and as the supporting salt solution, an aqueous solution in which 2 mol/L of HNO₃ is dissolved is used.

(Sample N)

Sample N of battery 10 is produced similarly to sample K except that as the positive electrode active material, an organic compound represented by formula (25) having a π electron conjugated cloud is used; as the negative electrode active material, an organic compound represented by formula (35) having a π electron conjugated cloud is used, and as the supporting salt solution, an aqueous solution in which 2 mol/L of HNO₃ is dissolved is used.

The summary of the above-mentioned configuration is shown in Table 2.

TABLE 2

| Bat- | | | Voltage |
|---|---|---|---|
| tery | Positive electrode side | Negative electrode side | range |
| Sam- | π electron conjugated | π electron conjugated | 0.0 V- |
| ple | compound of | compound of | 0.6 V |
| K | formula (36)/1 mol/L LiCl | formula (14)/1 mol/L LiCl | |
| | aqueous solution | aqueous solution | |
| Sam- | π electron conjugated | π electron conjugated | 0.0 V- |
| ple | compound of | compound of | 0.6 V |
| L | formula (37)/1 mol/L LiCl | formula (36)/1 mol/L LiCl | |
| | aqueous solution | aqueous solution | |
| Sam- | π electron conjugated | π electron conjugated | 0.2 V- |
| ple | compound of | compound of | 1.1 V |
| M | formula (30)/ | formula (29)/ | |
| | 2 mol/L nitric acid | 2 mol/L nitric acid | |
| | aqueous solution | aqueous solution | |
| Sam- | π electron conjugated | π electron conjugated | 0.1 V- |
| ple | compound of | compound of | 0.9 V |
| N | formula (25)/ | formula (35)/2 mol/L | |
| | 2 mol/L nitric acid | nitric acid aqueous | |
| | aqueous solution | solution | |

Next, each of these batteries is evaluated similarly to sample A. At this time, the upper limit voltage and lower limit voltage of charge and discharge are selected as shown in Table 2. These samples can be repeatedly charged and discharged 50 cycles or more. Furthermore, the capacity of the battery is hardly lowered even after the battery is charged and left for 30 days or more while pump 18A and pump 18B are stopped. In the case where glass paper is used for separator 13 in this way, no problem arises when the battery is subjected to the charging and discharging cycle or left in such a degree.

### Second Exemplary Embodiment

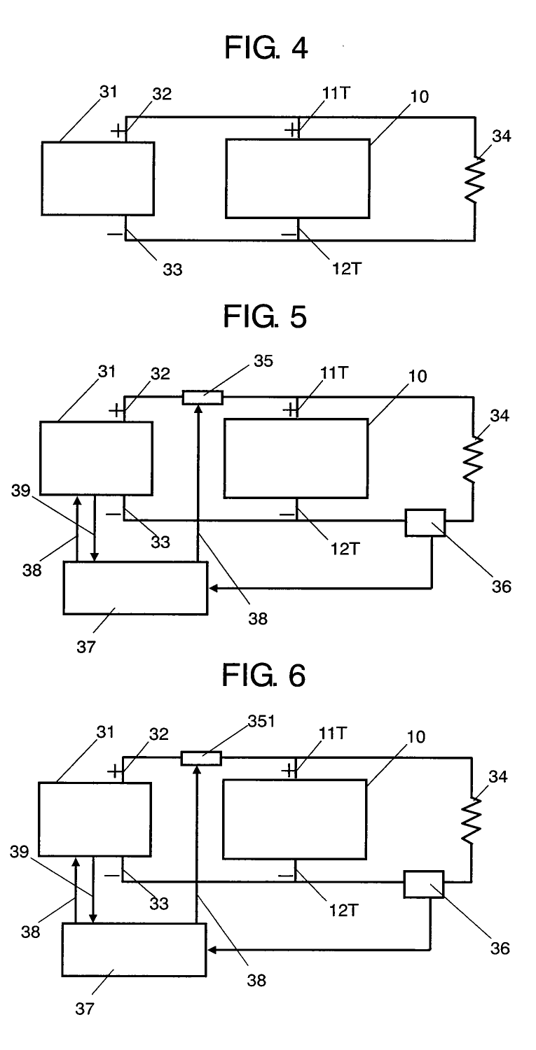

A power supply system applying the secondary battery described in the first exemplary embodiment is described. FIG. 4 is a conceptual diagram showing a power supply system combining a secondary battery in accordance with the first exemplary embodiment of the present invention and a fuel cell that is a power supply for supplying electric power to the secondary battery.

Positive electrode terminal 32 of fuel cell 31 is coupled to positive electrode terminal 11T of battery 10 and negative electrode terminal 33 is coupled to negative electrode terminal 12T, respectively, and both are coupled to load 34. That is to say, fuel cell 31 and battery 10 are coupled in parallel. Since battery 10 has a structure shown in FIG. 1, the description is omitted. Furthermore, although not shown, between battery 10 and fuel cell 31, a regulator for regulating the charging voltage is provided. Furthermore, it is preferable that a switch for selecting a circuit is provided in an arbitrary portion.

In this power supply system, battery 10 is constantly charged from fuel cell 31 and both fuel cell 31 and battery 10 can supply electric power to load 34. When the output from fuel cell 31 is short and does not meet the electric power of load 34, electric power is supplied from battery 10. That is to say, when the load of load 34 is changed, until fuel cell 31 can meet the change of the load, battery 10 aids the power supply to load 34. After fuel cell 31 becomes to meet the change of load, only fuel cell 31 supplies electric power to load 34 while fuel cell 31 charges battery 10. Thus, the remaining capacity of battery 10 can be maintained at a predetermined capacity.

In general, a fuel cell can operate most efficiently when the fuel cell outputs a predetermined steady-state power. Battery 10 performs a peak-cutting function and an energy accumulating function to meet the change in load 34. Thus, fuel cell 31 can be efficiently used. Furthermore, since battery 10 has a high-power property, this power supply system can be configured in a compact size. Furthermore, when tank 15A and 15B are separated from container 14 that is a charging and discharging portion, these tanks can be placed in a desired location.

Next, a power supply system having another configuration is described with reference to FIG. 5. The description of the same portions as those in FIG. 4 is omitted herein. Switch 35 is provided between battery 10 and fuel cell 31. Furthermore, between battery 10 and load 34, load current detector 36 is provided. Furthermore, although not shown, inside fuel cell 31, a device for detecting the state of fuel cell 31 is provided and sends state detection signal 39 from fuel cell 31 to fuel cell controller 37. Fuel cell controller 37 receives an output signal from load current detector 36 and state detection signal 39 from fuel cell 31, and sends control signal 38 to switch 35 and fuel cell 31. Furthermore, a predetermined energy is supplied from fuel cell 31 and accumulated in battery 10 in advance.

There will be described how each portion operates in the above configuration when fuel cell 31 responds to load change. Load current detector 36 detects an electric current flowing into load 34. Load current detector 36 sends a signal corresponding to the detected load current to fuel cell controller 37. Based on this signal, fuel cell controller 37 determines whether or not load change occurs. When it is determined that the load change occurs, fuel cell controller 37 sends control signal 38 to fuel cell 31 and switch 35.

Fuel cell 31 receives control signal 38 and changes the supplying amount of fuel so as to meet the load change. However, it takes a time for a fuel to be supplied to the entire membrane that is a reaction field of fuel cell 31. At the same time, switch 35 that receives control signal 38 opens the circuit. Then, electric power is supplied to load 34 only from battery 10. Thus, while a fuel corresponding to load 34 is supplied to fuel cell 31, fuel cell 31 can be free from having such failure as reduction of output or polarity inversion.

Then, when fuel cell controller 37 determines, based on signal 39 sent from fuel cell 31, that fuel cell 31 gets back the capability of managing the load current, fuel cell controller 37 sends control signal 38 to switch 35 so as to close switch 35. After fuel cell 31 gets back the capability of meeting the change of load 34, only fuel cell 31 supplies electric power to load 34 while it charges battery 10 so as to refuel the energy consumed.

Thus, it is possible to prevent the rapid reduction of output voltage and polarity inversion and to improve the lifetime and reliability of the fuel cell. Thus, it is possible to improve the stability and maintainability of the entire system.

Next, a power supply system having another configuration is described with reference to FIG. 6. The descriptions about the portions that are the same as in FIGS. 4 and 5 are omitted. In this configuration, regulator 351 for limiting the output is provided instead of switch 35 of FIG. 5. Fuel cell controller 37 receives an output signal from load current detector 36 and state detection signal 39 from the fuel cell, and sends control signal 38 to regulator 351 and fuel cell 31. Furthermore, a predetermined energy from fuel cell 31 is accumulated in battery 10 in advance.

There will be described how each portion operates in the above configuration when fuel cell 31 responds to load change. Load current detector 36 detects an electric current flowing into load 34. Load current detector 36 sends a signal corresponding to the detected load current to fuel cell controller 37. Based on this signal, fuel cell controller 37 determines whether or not load change occurs. When it is determined that the load change occurs, fuel cell controller 37 sends control signal 38 to fuel cell 31 and regulator 351.

Fuel cell 31 receives control signal 38 and changes the supplying amount of fuel to meet the load change. However, it takes a time to supply fuel to the entire membrane that is a reaction field of fuel cell 31. During this period of time, the electric power from fuel cell 31 solely is not sufficient to meet the electric power required for load 34. Therefore, battery 10 supplies electric current so as to make up the shortage. Fuel cell controller 37 that receives signal 39 for detecting the state of fuel cell 31 sends control signal 38 to regulator 351 and limits the output of fuel cell 31. When fuel cell controller 37 determines, based on signal 39, that fuel cell 31 is in a state capable of meeting the load current, fuel cell controller 37 sends control signal 38 to regulator 351 so as to release the output limit applied to fuel cell 31.

By responding to the load change in the order as mentioned above, while fuel cell 31 is supplied with fuel corresponding to load 34, fuel cell 31 can be free from such failure as reduction of output or polarity inversion. During this time, battery 10 compensates for the output of fuel cell 31 and supplies electric power to load 34. When fuel cell 31 gets back the capability of meeting the change of load 34, only fuel cell 31 supplies electric power to load 34 and charges the consumed energy of battery 10. In this case, since energy taken out from battery 10 at the time of load changing is reduced, the entire system gets a margin for responding to the maximum value of the output change.

Thus, rapid reduction of output voltage or polarity inversion can be prevented and lifetime and reliability of the fuel cell can be improved. Thus, stability and maintainability of the entire system can be improved. Furthermore, among similar systems that meet the same magnitude of maximum load current, the present system can reduce the capacity or the number of the batteries. Thus the entire cost of the present system can be reduced.

As mentioned above, in the power supply system in accordance with the exemplary embodiment, when load 34 exceeds the power supply capability of fuel cell 31 that is a power supply, electric power corresponding to the shortage is supplied from battery 10 to load 34. Then, after fuel cell 31 gets back the capability of supplying electric power corresponding to load 34, battery 10 is charged so that the remaining capacity of battery 10 is maintained at a predetermined capacity.

Furthermore, at the time of steady-state operation, fuel cell 31 supplies electric power to load 34. When load 34 is lower than the power supply capability of fuel cell 31, it is preferable that battery 10 is charged with surplus power of fuel cell 31. Thus, the power generation capacity of fuel cell 31 can be efficiently used. In general, fuel cell 31 that is operated while the output thereof is kept unchanged attains adequate power generation efficiency. Therefore, such an operation control as described above is preferable.

### Third Exemplary Embodiment

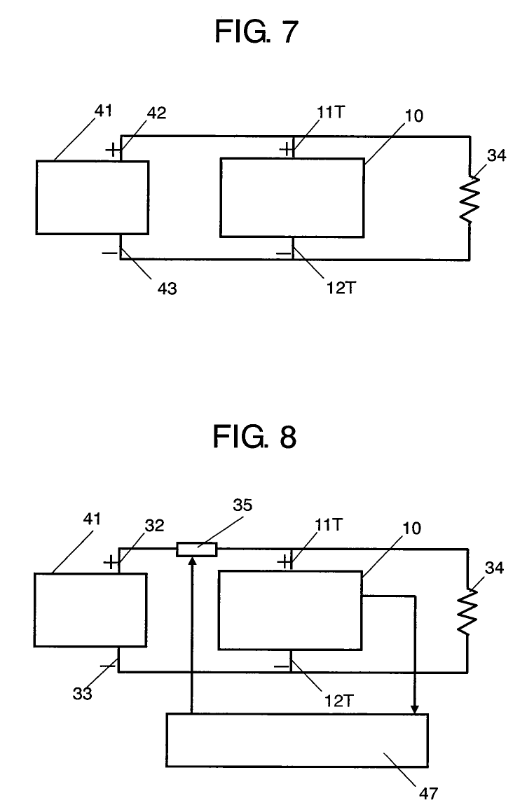

Next, another power supply system using the secondary battery described in the first exemplary embodiment is described. FIG. 7 is a conceptual diagram showing a power supply system that combines battery 10 and solar battery 41. Positive electrode terminal 42 of solar battery 41 is coupled to positive electrode terminal 11T of battery 10 and negative electrode terminal 43 is coupled to negative electrode terminal 12T, respectively, and both are coupled to load 34. Note here that since battery 10 has a structure shown in FIG. 1, the description thereof is omitted. Although not shown, between battery 10 and solar battery 41, a regulator for regulating the charging voltage is provided. Furthermore, it is preferable that a switch for selecting circuit is provided in arbitrary portions.

In this power supply system, battery 10 is constantly charged by solar battery 41. However, in general, an output from a solar battery varies depending upon the irradiation conditions of light including weather and time. In this power supply system, when the output from solar battery 41 is short with respect to load 34, battery 10 is discharged to compensate for the electric power. The output from solar battery 41 has a power enough to meet load 34, battery 10 is charged. Thus, solar battery 41 whose output varies can be efficiently used. In particular, since solar battery 41 is disposed in outdoor conditions, battery 10 having a wide operating temperature range works as a preferable compensation device in the electric power system.

Next, a power supply system having another configuration is described with reference to FIG. 8. The descriptions of the same portions as those in FIG. 7 are omitted. Although not shown, between battery 10 and solar battery 41, a regulator for regulating the charging voltage is provided. In addition, switch 35 or a regulator (not shown) is provided between solar battery 41 and battery 10. Furthermore, control portion 47 for detecting the charged state of battery 10 and controlling charging by solar battery 41 is provided.

Also in this power supply system, when the output from solar battery 41 is short with respect to load 34, battery 10 is discharged to compensate for the electric power. When the output from solar battery 41 has a power enough to meet load 34, battery 10 is charged. Herein, battery 10 is charged by solar battery 41 with the help of switch 35 or the regulator that is controlled by control portion 47 in accordance with the charging state of battery 10. On the occasion having no load, battery 10 is controlled to a fully charged state. When control portion 47 determines that battery 10 is fully charged and that no load 34 is applied and furthermore, when solar radiation is continued, control portion 47 controls switch 35 or the regulator so as to stop the charging.

Then, when electric power is supplied to load 34, control portion 47 blocks the electric power from solar battery 41 with switch 35 or regulates it with the regulator. Thus, only battery 10 supplies electric power to load 34. Alternatively, battery 10, as an auxiliary power supply, supplies the shortage of electric power that is not met only by the power generation of solar battery 41, and thereby stable electric power, indifferent to the amount of solar radiation at that time, can be supplied to load 34.

Thus, solar battery 41 whose output varies can be efficiently used. Battery 10 can efficiently accumulate the output of solar battery, which is intensely varies by the amount of solar radiation. In particular, since solar battery 41 is disposed in outdoor conditions, battery 10 having a wide operating temperature range works as a preferable compensation device in the electric power system.

Furthermore, in this system, when the amount of the electric power charged by solar radiation exceeds the amount of the electric power consumed, battery 10 may be over-discharged. Therefore, for the purpose of having an additional assistance and backup, a commercial power supply may be combined. Such a configuration can provides a stable power supply system, in which the electric power generated by solar battery 41 can be efficiently used while the spending for the commercial power supply is saved.

As mentioned above, in the power supply system in accordance with the exemplary embodiment, when load 34 exceeds the power supply capability of solar battery 41 as a power supply, the electric power corresponding to the shortage is supplied from battery 10 to load 34. Then, after solar battery 41 gets back the capability of managing the electric power corresponding to load 34, battery 10 is charged so that the remaining amount of battery 10 is maintained at a predetermined capacity.

Furthermore, when load 34 is smaller than the power supply capability of solar battery 41, it is preferable that battery 10 is charged with surplus power of solar battery 41. Thus, the power generation capacity of solar battery 41 can be efficiently used.

### Fourth Exemplary Embodiment

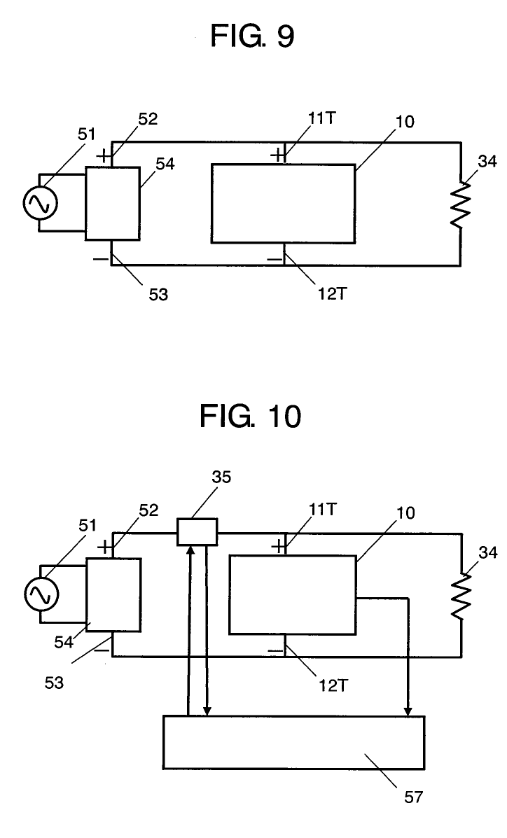

Next, still another power supply system using the secondary battery described in the first exemplary embodiment is described. FIG. 9 is a conceptual diagram showing a combined power supply system of battery 10 and commercial power supply 51. Commercial AC power supply 51 is coupled to rectifier circuit 54 such as a rectifier or a converter having a function of converting AC to DC. Rectifier circuit 54 has positive electrode terminal 52 and negative electrode terminal 53 on the output side thereof. Positive electrode terminal 52 is coupled to positive electrode terminal 11T of battery 10 and negative electrode terminal 53 is coupled to negative electrode terminal 12T, respectively. Both are coupled to load 34. That is to say, rectifier circuit 54 coupled to commercial power supply 51 and battery 10 are coupled in parallel. Since battery 10 has a structure shown in FIG. 1, the description is omitted. Although not shown, between battery 10 and rectifier circuit 54, a regulator for regulating the charging voltage is provided. In addition, it is preferable that a switch for selecting a circuit is provided in arbitrary portions.

In this power supply system, battery 10 is constantly charged by commercial power supply 51 in a constant-current system or a constant-voltage system. Battery 10 accumulates electric power from commercial power supply 51 for emergency such as power failure, or plays a role of managing the case where load 34 is largely changed instantly. That is to say, when the size of load 34 is changed, until commercial power supply 51 responds to the load change, battery 10 auxiliary supplies electric power to load 34. After commercial power supply 51 responds to the load change, only commercial power supply 51 supplies electric power to load 34 and at the same time commercial power supply 51 charges battery 10. Battery 10 having an excellent high-power property becomes an effective compensation device in such a combined system. Alternatively, at the time and seasons when an electric power demand is small, for example, at night and in spring and autumn, battery 10 is charged; and at the time and seasons when an electric power demand is large, for example, in a daytime and in summer and winter, battery 10 is discharged, thus contributing to leveling the load of electric power.

Next, a power supply system with another configuration is described with reference to FIG. 10. The descriptions of the same portions as in FIG. 9 are omitted. Although not shown, between battery 10 and rectifier circuit 54, a regulator for regulating the charging voltage is provided. Between battery 10 and rectifier circuit 54, switch 35 or a regulator (not shown) is provided. The regulator is the same as adjuster 351 shown in FIG. 6. Furthermore, controlling portion 57 for detecting the charged state of battery 10 and controlling charging by commercial power supply 51 is provided. Furthermore, it is desirable that switch 35 or the regulator is provided with a function for measuring electric current so as to transmit an electric current signal to control portion 57.

In this power supply system, control portion 57 controls switch 35 or a regulator in accordance with the charged state of battery 10. Battery 10 is charged by commercial power supply 51 by the operation of switch 35 or the regulator in a constant-current system or a constant-voltage system. On the occasion of having no load, battery 10 is controlled to a fully charged state.

When control portion 57 receives a signal from battery 10 and determines that battery 10 is fully charged and no load is applied, control portion 57 controls switch 35 or the regulator so as to stop charging. In the case where load 34 is within an allowance of a breaker, control portion 57 supplies electric power to load 34 while battery 10 keeps being charged. With such a control, battery 10 accumulates electric power from commercial power supply 51 for emergency such as power failure. Alternatively, when load 34 changes so that it exceeds the permissible value of the breaker, battery 10 auxiliary supplies electric power to load 34. After commercial power supply 51 gets back the capability of managing the load change, commercial power supply 51 supplies electric power to load 34 and at the same time charges battery 10.

Control portion 57 desirably controls switch 35 or the regulator by using the function for measuring electric current that is furnished in switch 35 or the regulator, so that the permissible value of the breaker is not exceeded. With such a control, maximum electric power is supplied from commercial power supply 51 and electric power corresponding to the shortage can be compensated by battery 10.

Battery 10 having an excellent high-power property, in such a combined system, rapidly charges energy consumed, and thereby electric power can be supplied stably against repeated power failures. Furthermore, battery 10 having an excellent high-power property, in such a combined system, can respond with smaller capacity to a transient change of load and supply electric power stably against the temporary rapid increase of the load. At this time, the power supply is not blocked beyond the allowance of the breaker.

Alternatively, in such a combined system, battery 10 having an excellent high-power property is mainly charged at the time and in seasons when an electric power demand is small, for example, at night and in spring and autumn; and battery 10 is mainly discharged at the time and in seasons when an electric power demand is large, for example, in a daytime and in summer and winter. Thereby, battery 10 contributes to leveling the load of electric power. Thus, battery 10 having an excellent high-power property works as an efficient electric power compensation device in such a combined system. That is to say, when load 34 is lower than the power supply capability of commercial power supply 51, battery 10 is desirably charged with the surplus power of commercial power supply 51.

As mentioned above, in the power supply system in accordance with the exemplary embodiment, when load 34 exceeds the power supply capability of commercial power supply 51 serving as a power supply, battery 10 also supplies electric power to load 34 so as to make up the shortage. Then, after commercial power supply 51 gets back the capability of supplying electric power corresponding to load 34, battery 10 is charged again so that the remaining capacity of battery 10 is maintained.

As mentioned above, battery 10 of the first exemplary embodiment does not contain a heavy metal as a complex and has an excellent environmental load property and exerts an excellent lifetime property. Furthermore, as in the second to fourth exemplary embodiments, by configuring a combined power supply system by fuel cell 31, solar battery 41 and commercial electric power 51, disadvantages of the other electric power system (power supply) are compensated and thereby each feature can be effectively exerted. In other words, when the load change exceeds the capability of the power supply other than the secondary battery of the present invention, or when the capability of the power supply is deteriorated and is not sufficient with respect to load, the secondary battery supplies electric power to the load to make up the shortage.

Note that, in the second to fourth exemplary embodiments, any of fuel cell 31, solar battery 41 and commercial power supply 51 is combined with battery 10. However, in addition to the battery, the other power supply may be mixed and combined.

When battery 10 is in a state close to fully charged, a side reaction other than the battery reaction easily occurs. Therefore, if such a state is lasting for a long time, battery 10 is deteriorated in performance. Therefore, in the power supply system, as described in the second to fourth exemplary embodiments, when the charge depth (remaining capacity) goes over a predetermined value, it is preferable that control portions 37, 47 and 57 allow battery 10 to discharge so as to reduce the charge depth. That is to say, the remaining capacity of battery 10 is desirably maintained at the predetermined capacity. Thus, the lifetime of battery 10 is increased, and the cycle deterioration is suppressed. Such a control may be applied to the power supply system in the third exemplary embodiment or the power supply system of the fourth exemplary embodiment.

### INDUSTRIAL APPLICABILITY

A secondary battery of the present invention is stable and has a long operation life. As a new electric power supply, the secondary battery is expected to be advantageously used for applications from small to large, including not only providing portable devices and improving mountability thereof on electric equipment but also electric vehicles and the like as a mobile power supply, energy storage, and load leveling for electric power.

1. A secondary battery comprising:
a positive electrode active material;
a positive electrode current collector for oxidizing and reducing the positive electrode active material;
a negative electrode active material;
a negative electrode current collector for oxidizing and reducing the negative electrode active material; and
an ion conducive separator for separating at least between the positive electrode active material and the negative electrode active material;
wherein at least one of the positive electrode active material and the negative electrode active material is an organic compound reversibly electrochemically oxidized and reduced in a liquid state in a coexistence of a supporting salt, and
wherein the organic compound has one of a structure represented by any of general formula (1), general formula (2), general formula (3), general formula (4) and general formula (5), and a structure having a thiol group in a molecule; 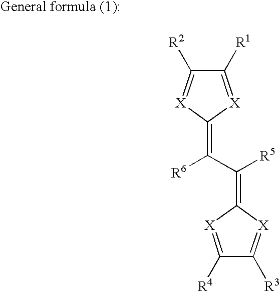
wherein X represents a nitrogen atom; R¹ to R⁴ each independently represents a chain saturated or unsaturated aliphatic group, a cyclic saturated or unsaturated aliphatic group, a hydrogen atom, a hydroxyl group, a cyano group, an amino group, a nitro group or a nitroso group; R⁵ and R⁶ each independently represents a chain saturated or unsaturated aliphatic group or a cyclic saturated or unsaturated aliphatic group; and the aliphatic group includes at least one selected from the group consisting of an oxygen atom, a nitrogen atom, a sulfur atom, a silicon atom, a phosphorus atom, a boron atom and a halogen atom, 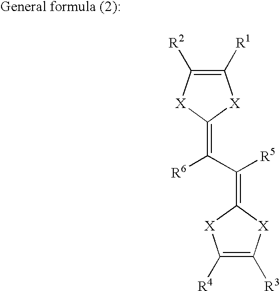
wherein X represents a sulfur atom or an oxygen atom; R¹ to R⁴ each independently represents a chain saturated or unsaturated aliphatic group, a cyclic saturated or unsaturated aliphatic group, a hydrogen atom, a hydroxyl group, a cyano group, an amino group, a nitro group or a nitroso group; R⁵ and R⁶ each independently represents a chain saturated or unsaturated aliphatic group, or a cyclic saturated or unsaturated aliphatic group; and the aliphatic group includes at least one selected from the group consisting of an oxygen atom, a nitrogen atom, a sulfur atom, a silicon atom, a phosphorus atom, a boron atom and a halogen atom, 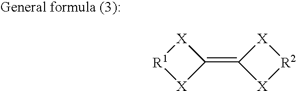
wherein R¹ and R² each independently represents a chain saturated or unsaturated aliphatic group, or a cyclic saturated or unsaturated aliphatic group; X represents a sulfur atom, an oxygen atom, or a tellurium atom; and the aliphatic group includes at least one selected from the group consisting of a hydrogen atom, an oxygen atom, a nitrogen atom, a sulfur atom, a silicon atom, a phosphorus atom, a boron atom and a halogen atom, 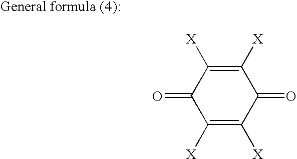
wherein X represents a halogen atom, a hydrogen atom, a cyano group, a chain saturated or unsaturated aliphatic group, or a cyclic saturated or unsaturated aliphatic group; and the oxygen atom is bounded to a para position or an ortho position of a six-membered ring, 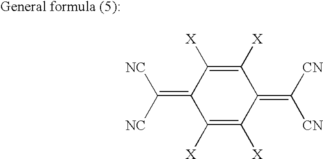
wherein X represents a halogen atom, a hydrogen atom, a cyano group, a chain saturated or unsaturated aliphatic group, or a cyclic saturated or unsaturated aliphatic group.

2. The secondary battery according to claim 1, further comprising:
a container for containing the organic compound and at least one of the positive electrode current collector and the negative electrode current collector; and
a supplying portion for supplying the organic compound from outside of the container;
wherein any of the positive electrode current collector and the negative electrode current collector contained in the container oxidizes and reduces the organic compound.

3-5. (canceled)

6. A power supply system comprising:
a secondary battery according to claim 1; and
a power supply for supplying electric power to the secondary battery.

7. The power supply system according to claim 6, wherein the power supply comprises at least one of a fuel cell, a solar battery and a commercial power supply.

8. A method of using a power supply system according to claim 6 comprising:
(i) when a load consuming electric power of the power supply system exceeds a power supply capability of the power supply, supplying electric power corresponding to a shortage of electric power from the secondary battery to the load; and
(ii) after the power supply gets back the capability of supplying electric power corresponding to the load, charging the secondary battery so that a remaining capacity of the secondary battery is maintained at a predetermined capacity.

9. The method according to claim 8, wherein in (i), only the electric power of the secondary battery is supplied to the load.

10. The method according to claim 8, further comprising:
(iii) when the remaining capacity of the secondary battery becomes the predetermined remaining capacity or more, discharging the secondary battery so that the remaining capacity of the secondary battery is maintained at the predetermined capacity.

11. A method of using a power supply system according to claim 6 comprising:
(i) supplying electric power from the power supply to a load consuming electric power of the power supply system;
(ii) when the load is lower than a power supply capability of the power supply, charging the secondary battery with surplus power of the power supply.

12. The method according to claim 11, further comprising:
(iii) when a remaining capacity of the secondary battery becomes a predetermined remaining capacity or more, discharging the secondary battery so that the remaining capacity of the secondary battery is maintained at the predetermined capacity.
